(19) United States
(12) Patent Application Publication
(10) Pub. No.: US 2021/0061191 A1
(43) Pub. Date: Mar. 4, 2021

(54) Car Tails

(71) Applicants: Jamie Lynn King, Bixby, OK (US); Wallace W. Frazier, II, Bixby, OK (US)

(72) Inventors: Jamie Lynn King, Bixby, OK (US); Wallace W. Frazier, II, Bixby, OK (US)

(21) Appl. No.: 16/558,225

(22) Filed: Sep. 2, 2019

(51) Int. Cl. B60R 13/04

(52) U.S. Cl. CPC B60R 13/04

(57) ABSTRACT

The present invention comprises a novel decorative device generally consisting of a flexible structural member, a water resistant cover, and an attachment clip and straps. The device has the form of an animal tail, and attaches to the rear of an automobile by attaching the clip to a fixed element inside the trunk of the automobile, while the main body of the tail protrudes externally behind the automobile, giving the appearance as if the automobile has a tail.

### FIELD OF THE INVENTION

The present invention relates to novel automobile accessories and apparatuses for transforming the appearance of an automobile into an animal, or one of various types of animals. More particularly, the invention relates to a decorative item that is internally fastened and secured, and protrudes external to the vehicle that gives the appearance of an animal tail that is carried by the wake of a moving vehicle.

### BACKGROUND

Vehicle adornment is a rapidly growing trend. Items in the field of the present invention include car eyelashes, which attach to the vehicle headlights, giving the appearance of the headlights as an eye with eyelashes; and car antlers. Car antlers are an item in the field of vehicle adornments that typically appear during the Christmas holiday season. Car antlers consist of a pair of felt covered molded antlers, with an attachment at the end which hook onto the top edge of a vehicle window, and are made fast when the window is in the “all the way up” position.

### BRIEF SUMMARY OF THE INVENTION

The present invention comprises a novel decorative automobile accessory which attaches to the vehicle and protrudes externally. The present invention generally consists of a means of attachment and securing to the vehicle, an outer covering, and internal structural members.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts an exploded view of the constituent parts of the present invention.

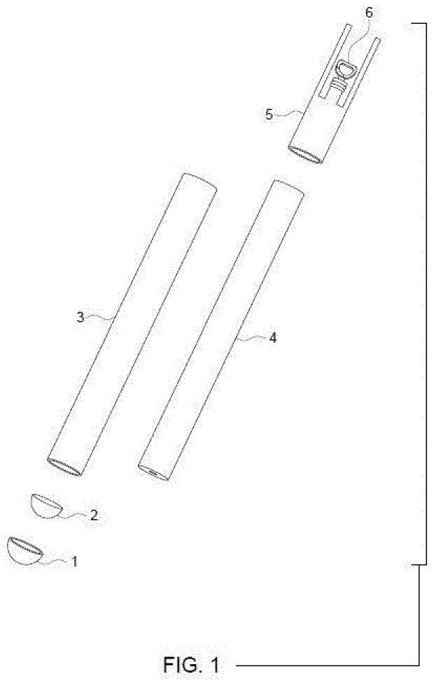

FIG. 2—FIG. 2 shows a view of the current invention from the rear or back end.

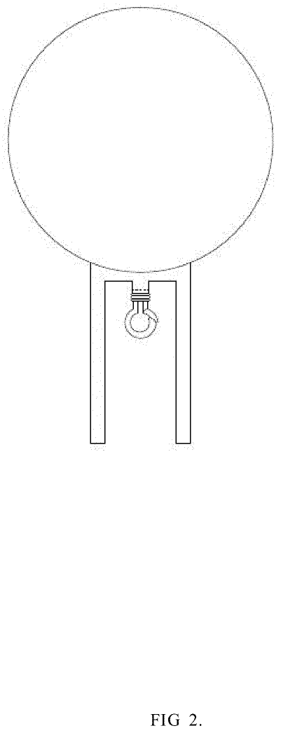

FIG. 3—FIG. 3 illustrates a view of the invention from above; as if the observer were looking down upon the device.

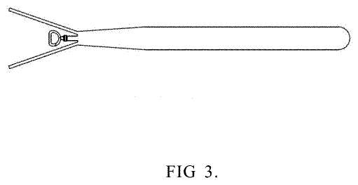

FIG. 4—FIG. 4 illustrates a view of the current invention as seen from the side.

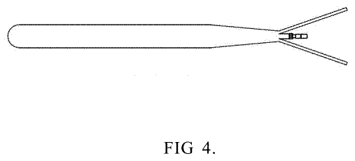

FIG. 5—FIG. 5 depicts a view of the present invention from the connection end; the front of the item that attaches to the automobile.

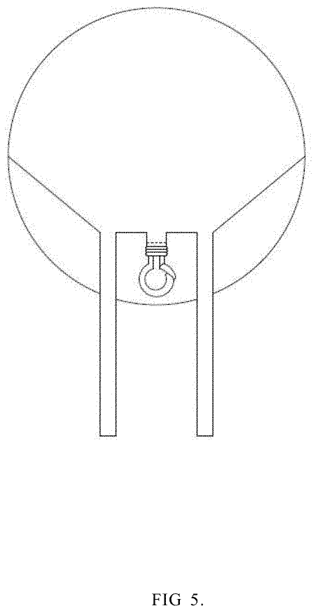

FIG. 6—FIG. 6 depicts the attachment clip of the present invention, connecting the present invention to an automobile

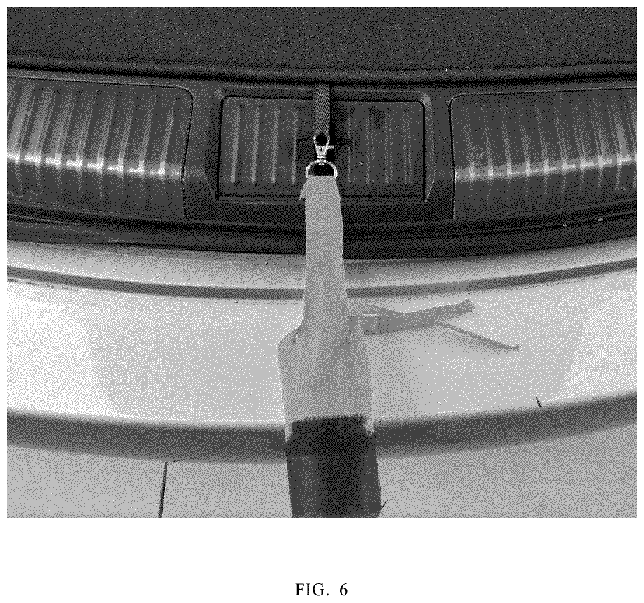

FIG. 7—FIG. 7 depicts a rear view of the present invention protruding from an automobile.

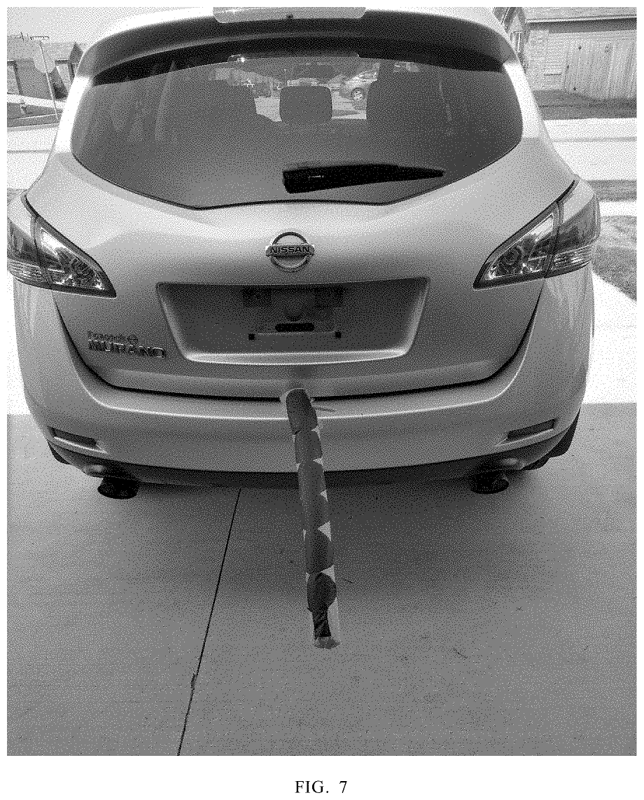

FIG. 8—FIG. 8 depicts an angled view of the present invention protruding from an automobile.

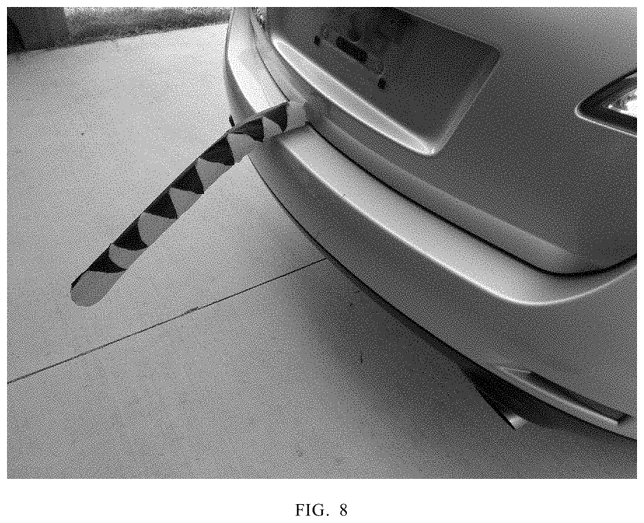

### DETAILED DESCRIPTION OF THE INVENTION

The present invention is described as a decorative assembly that takes the form of an animal tail, and is attached internal to the decorated vehicle, and which protrudes externally from the decorated vehicle. The described invention can take the form of many types of animals, such as mammals, avian animals or birds, fish, or aquatic mammals. The streaming cart tail assembly consists of two basic components, the internal structural member, and the external cover. The internal structural member consists of polyethylene foam that is cut and shaped to form the specific tail shape. The external cover is comprised of nylon fabric, or any other water resistant or weather resistant fabric. The entire assembly is divided into three sections; the tail section which gives the embodiment the appearance of an animal's tail, the transition section which transitions the assembly between the structural member and the connection section, and the connection section which attaches the assembly to the decorated vehicle. The connection section consists of two ties on the outside of the assembly, and a center connection piece which has a D-ring and clip assembly for attaching to the decorated vehicle. One particular embodiment described above is that of a mammal tail, the construction of which is described hereafter.

The present embodiment is constructed by preparing the individual components separately, and then integrating the individual components into a single, complete assembly.

The structural, inner member is prepared by cutting a section of polyethylene foam tube that has the desired outer diameter, to the prescribed length. Once the desired length is obtained, one end of the tube is shaved to a rounded taper.

The outer member, or sock is formed by cutting a rectangular sheet of nylon, or other water and weather resistant material, to the prescribed dimensions. The length of the rectangular sheet should be 9-12 inches longer than the polyethylene foam tube to allow for the connection section of the assembly. The width of the rectangular sheet should be one half inch in excess of the circumference of the polyethylene foam tube to allow for closing the nylon cover by stitching the long edges of the rectangular nylon sheet together.

The tail end of the nylon cover is constructed by folding the nylon sheet into fourths along the length of the sheet, and cutting equally angled sections out of both sides of the quartered end. The result is the creation of four equal triangles on the tail end of the nylon sheet. The tail end is then made to form a tapered closing by stitching the corresponding edges of two adjacent triangles. This is repeated until all four triangles have each of their angled sides stitched to the two adjacent triangles.

After the tail end of the nylon cover is closed, the nylon sheet is formed into a tube that is tapered and closed at one end as previously described, by stitching together of the long sides of the nylon sheet. This results in a tube that is tapered and closed at one end, and squared and open at the other. The open, squared end will form the connection section.

The connection section is constructed by laying the cover, or sock flat in a manner such that the seam or stitching that runs the length of the cover is positioned in the middle of the assembly such that there are equal lengths between the seam and both edges. With the cover situated in this manner, the outer ties are prepared by cutting a line on the top and bottom of each side such that the cuts begin one quarter of an inch from the outer edges of the cover's width and run approximately nine inches lengthwise. The center tie is prepared by position the cover in the same manner as the positioning for preparing the outer ties. With the cover positioned in this manner cuts are made on the top and bottom of the cover originating one quarter of an inch from the center of the assembly at the edge of the length of the cover. This cut is made from the edge, lengthwise for approximately six inches. At the six inch point in the cut, the cut is then angled towards the endpoint of the cut for the outer ties, where the cuts for the outer and center ties meet. Cuts for the center tie, as just described are made, originating on both sides of the center of the cover assembly, and ending at the end points of both outer ties. With the cover prepared in this manner, the assembly is prepared for insertion of the polyethylene foam tube structural member.

Completion of the embodiment consists of inserting the structural member into the cover assembly. This is performed by turning the cover inside out such that the stitches along the length of the cover are on the inside. With the cover situated in this manner, the tapered end of the structural member is inserted into the cover at the connection section end. Once inserted, the structural member is pushed into the cover until the tapered end of the structural member is inside the tapered or rounded section of the cover, leaving no slack. This completes the insertion of the structural member.

With the structural member inserted into the cover or sock, the assembly is ready to be closed. The assembly is closed by stitching together the corresponding edges of the tops and bottoms of the outer and center ties.

The final step in the construction of the present embodiment consists of attaching the clip to the center tie. The clip is attached by pushing the end of the center tie through the clip's D-ring, and stitching the edge of the center tie that was run through the D-ring to a portion of the center tie that is not pushed through the D-ring. With the center tie looped through the D-ring and seen together, the construction and assembly of the present embodiment of this invention is complete.

What is claimed is:

1. A decorative assembly or device that attaches to the rear of a vehicle that gives the vehicle the appearance of having an animal tail consisting of:
a. a structural member,
b. a cover, and
c. a means of attaching the assembly or device to the vehicle.
